(19) United States
(12) Patent Application Publication
(10) Pub. No.: US 2008/0037520 A1
(43) Pub. Date: Feb. 14, 2008

(54) Residential Gateway Translating Call Signaling Text Received With a Packet-Switched Telephony Call

(75) Inventors: Robert C. Stein, Coopersburg, PA (US); Phillip Kent Freyman, Elgin, IL (US)

Correspondence Address: Motorola, Inc.;Law Department, 1303 East Algonquin Road, 3rd Floor, Schaumburg, IL, 60196, US

(73) Assignees: Robert C. Stein, Coopersburg, PA (US); Phillip Kent Freyman, Elgin, IL (US)

(21) Appl. No.: 11/461,187

(22) Filed: Jul. 31, 2006

(51) Int. Cl. H04L 12/66

(52) U.S. Cl. 370/352

(57) ABSTRACT

A method and apparatus is provided for presenting information associated with a packet-switched telephony call received over a broadband communications network. The method includes receiving a packet-switched telephony call that includes an incoming machine-readable text string incorporated in a signal that conforms to a packet-switched telephony signaling protocol. The incoming machine-readable text string is translated to a predefined corresponding text string that represents the machine-readable text string in a human-readable language. Finally, the corresponding text string is presented to an end user. The aforementioned method may be performed by a residential gateway or the like.

### FIELD OF THE INVENTION

This invention relates generally to the provision of real-time services over a packet network, and more particularly to the provision of Internet telephony to transport voice and data over a broadband communications network such as a HFC network, an xDSL network, and the like.

### BACKGROUND OF THE INVENTION

Today, access to the Internet is available to a wide audience through the public switched telephone network (PSTN). Typically, in this environment, a user accesses the Internet though a full-duplex dial-up connection through a PSTN modem, which may offer data rates as high as 56 thousand bits per second (56 kbps) over the local-loop plant.

However, in order to increase data rates (and therefore improve response time), other data services are either being offered to the public, or are being planned, such as data communications using full-duplex cable television (CATV) modems, which offer a significantly higher data rate over the CATV plant than the above-mentioned PSTN-based modem. Services being offered by cable operators include packet telephony service, videoconference service, T1/frame relay equivalent service, and many others.

Various standards have been proposed to allow transparent bi-directional transfer of Internet Protocol (IP) traffic between the cable system headend and customer locations over an all-coaxial or hybrid-fiber/coax (HFC) cable network. One such standard, which has been developed by the Cable Television Laboratories, is referred to as Interim Specification DOCSIS 1.1. Among other things, DOCSIS 1.1 specifies a scheme for service flow for real-time services such as packet telephony (“Voice over IP” or “VoIP”). Packet telephony may be used to carry voice between telephones located at two endpoints. Alternatively, packet telephony may be used to carry voice-band data between endpoint devices such as facsimile machines or computer modems.

Voice over IP telephony allows individuals in different locations to communicate with each other over an IP network, just as users have traditionally communicated over voice telephones using Public Switched Telephone Networks (PSTN). In addition to voice, IP telephony may include a combination of video, still image, and data information during a communication session. Broadband networks such as HFC networks, xDSL networks and the like are providing telephony services using, for instance, the Voice Over Internet Protocol (VoIP) and the Data Over Cable Service Interface Specification (DOCSIS). Operators of such networks may want to provide services having the same or higher level of availability as that of the competing Local Exchange Carrier (LEC) or other telephony service provider. When using IP to carry voice, some connections can stay on the IP network while others must connect to the public switched telephone network (PSTN) to allow calls to non-IP subscribers. CableLabs is a cable industry funded organization which is defining the PacketCable series of standards that define a full suite of VoIP capabilities.

Several different types of signaling protocols are used to establish connections (e.g., point-to-point conversations) between end-user IP telephony devices. The most common signaling protocols are the Session Initiation Protocol (SIP), the H.323 protocol, and PacketCable network-based call signaling (NCS).

To provide enhanced services such as text and the like so that they offer enhanced flexibility to network operators, methods and apparatuses are needed that work in tandem with the various call signaling standards. In particular, text-based information received with incoming call signaling is generally only provided in a certain language in any given region and, as a result, individuals (e.g., immigrants or people of different nationalities living in the given region) do not have the benefit of the text-based information being displayed in the language of their choice.

### SUMMARY OF THE INVENTION

In accordance with the present invention, a residential gateway provides packet-switched telephony service over a broadband communications network. The gateway includes data terminal equipment having an interface for communicating with customer premises equipment and an electronic memory configured to store a directory that associates an incoming text string incorporated in a signal that conforms to a packet telephony signaling protocol with a corresponding text string. The incoming text string is a machine-readable text string and the corresponding text string represents the machine-readable text string in a human-readable language. A processor is configured to receive the incoming text string and retrieve from the memory the corresponding text string for presentation to customer premises equipment.

In accordance with one aspect of the invention, the packet-switched telephony signaling protocol may be an IP-based telephony signaling protocol.

In accordance with another aspect of the invention, the IP-based telephony signaling protocol may be NCS.

In accordance with another aspect of the invention, the IP-based telephony signaling protocol may be SIP.

In accordance with another aspect of the invention, the incoming text string may specify that a phone number of an incoming caller is unavailable or blocked.

In accordance with another aspect of the invention, the directory stored by the electronic memory may associate the incoming text string with a plurality of different corresponding text strings.

In accordance with another aspect of the invention, each of the corresponding text strings may represent a human-readable text string in a different language.

In accordance with another aspect of the invention, a broadband modem may be provided for communicating data between the data terminal equipment and the broadband communications network.

In accordance with another aspect of the invention, a second electronic memory segment may be provided which is configured to store a directory that associates a telephone number incorporated in the signal with a name of a calling party associated with the telephone number.

In accordance with another aspect of the invention, the customer premises equipment may be a telephone.

In accordance with another aspect of the invention, the packet-switched telephony connection may conform to a voice-over-IP protocol.

In accordance with another aspect of the invention, a computer readable medium may be provided which contains instructions to cause a processor to perform a method of presenting information associated with a packet-switched telephony call received over a broadband communications network The method begins by receiving a packet-switched telephony call that includes an incoming machine-readable text string incorporated in a signal that conforms to a packet-switched telephony signaling protocol. The incoming machine-readable text string is translated to a predefined corresponding text string that represents the machine-readable text string in a human-readable language. Finally, the corresponding text string is presented to an end user.

### BRIEF DESCRIPTION OF THE DRAWINGS

FIG. 1 shows an illustrative voice-over-IP communications system in accordance with the principles of the invention.

FIG. 2 shows an illustrative representation of the text translator database incorporated in the MTA or residential gateway shown in FIG. 1.

FIG. 3 is an alternative embodiment of the residential gateway or MTA shown in FIG. 1.

FIG. 4 is a flowchart illustrating one method by a residential gateway or MTA translates and presents information to a customer in accordance with the principles of the invention.

FIGS. 5-9 are flowcharts showing various examples of processes performed by the MTA.

FIGS. 10 and 11 show examples of the information that may be available in the caller ID translation data file.

### DETAILED DESCRIPTION

As detailed below, a text translation arrangement is provided in a packet telephony arrangement such as a voice-over-IP system. In this way, the conventional text-based information received with incoming call signaling can be conveniently presented to the end user in the end user's native language or any other desired language.

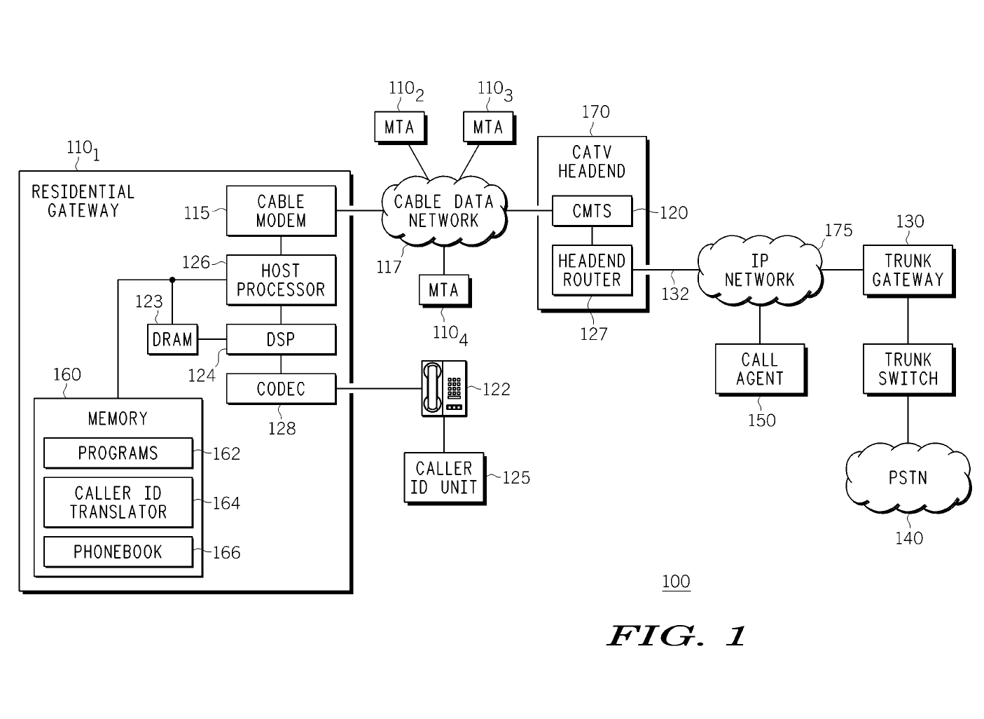

An illustrative communications network 100 that includes a broadband access network is shown in FIG. 1. Communications network 100 is representative of a network architecture in which subscribers associated with subscriber or residential gateways such as embedded multi-media terminal adapters (eMTAs) or stand-alone multi-media terminal adapters (sMTAs) may access the Public Internet and a Public Switched Telephone Network (PSTN) 140. In particular, MTAs 110₁-110₄ are in communication with the Public Internet via broadband access network 117 such as a CATV network, for example, and an MSO Managed IP Network 175. The Broadband access network, which includes the HFC access network 117 and the headend 170, is provided by an MSO (Multi-Service Operator) In this context, it is assumed the MSO provides head-end 170 and cable modem 115. This HFC access network 117 is also referred to herein as a cable data network. HFC access network 117 is typically an all-coaxial or a hybrid-fiber/coax (HFC) cable network. MTAs 110₁-110₄ is also in communication with PSTN 140 via the cable network, IP network 175, and trunk gateway 130. Of course, other broadband access networks such as xDSL (e.g., ADSL, ADLS2, ADSL2+, VDSL, and VDSL2) may also be employed. In some of these access networks the MTA is sometimes referred to as an analog telephony adaptor (ATA).

As shown in FIG. 1 for residential gateway or MTA 110₁, the MTAs 110₁-110₄ include customer premises equipment 122, e.g., a telephone, a CODEC 128, a Digital Signal Processor (DSP) 124, host processor 126 and Cable Modem (CM) 115. CODEC 128, DSP 124, and host processor 126 are collectively representative of data terminal equipment, which is coupled to communications link 117 via CM 115 to provide communications services to a user of telephone 122. CM 115 provides the access interface to the cable data network via an RF connector and a tuner/amplifier (not shown). Broadly speaking, DSP 124 generates data packets from the analog signals received from the telephone 122. That is, DSP 124 and CODEC 128 collectively perform all of the voice band processing functions necessary for delivering voice and voice-band data over a cable network, including echo cancellation, packet loss concealment, call progress tone generation, DTMF/pulse and fax tone detection, audio compression and decompression algorithms such as G.723 and G.729, packet dejittering, and IP packetization/depacketization. Typically, DSP 124 encodes the data with pulse code modulated samples digitized at rates of 8, 16 or 64 kHz. Host processor 126 receives the data packet from the DSP 124 and adds an appropriate header, such as required by the MAC, IP, and UDP layers. Once the packet is complete, it is sent to CM 115, where it remains in a queue until it is transmitted over the cable data network to the CMTS 120 in the CATV headend 170. For the purposes of the present invention, the service being provided is assumed to be a real-time service such as packet telephony. Accordingly, the data packets should be formatted in accordance with a suitable protocol such as the Real-Time Transport Protocol (RTP).

In other broadband access networks the CM 115 is replaced with a broadband modem suitable for use with the standards and protocols employed by that network. For example, in an xDSL access network, the functionality of the CM 115 would be performed by an xDSL modem.

An Internet Service Provider (ISP) provides Public Internet access. In the context of FIG. 1, it is assumed an ISP provides the IP network, which includes an Internet Gateway 130 attached to communications link 132. It should be noted that for illustrative purposes only it is assumed that the above-mentioned MSO and ISP Service Provider are different entities. The Internet Gateway 130 may be provided by either the MSO or the ISP Service Provider.

CM 115 is coupled to CATV head-end 170 via cable network 117, which is, e.g., a CATV radio-frequency (RF) coax drop cable and associated facilities. CATV head-end 170 provides services to a plurality of downstream users (only one of which is shown) and comprises cable modem data termination system (CMTS) 120 and head-end router 125. (CMTS 120 may be coupled to head-end router 127 via an Ethernet 100BaseX connection (not shown).) CMTS 120 terminates the CATV RF link with CM 115 and implements data link protocols in support of the residential service that is provided. Given the broadcast characteristics of the RF link, multiple residential customers and, hence, potentially many home-based LANs may be serviced from the same CMTS interface. Also, although not shown, those of skill in the art will readily appreciate that the CATV network may include a plurality of CMTS/head-end router pairs.

CM 115 and CMTS 120 operate as forwarding agents and also as end-systems (hosts). Their principal function is to transmit Internet Protocol (IP) packets transparently between the CATV headend and the customer location. Interim Specification DOCSIS 1.1 has been prepared by the Cable Television Laboratories as a series of protocols to implement this functionality.

In a full voice-over-Internet communication system, a Call Agent 150 is the hardware or software component that provides the telephony intelligence in the communications system and is responsible for telephone call processing. In particular, Call Agent 150 is responsible for creating the connections and maintaining endpoint states required to allow subscribers to place and receive telephone calls, to use features such as call waiting, call forwarding and the like. The call agent 150 uses an IP-based telephony signaling protocol such as PacketCable's Network Call Signaling (NCS) protocol to manage the setup and tear down of voice connections over the IP network 175. The NCS protocol contains signaling such as off hook, ring, connection, disconnection, and the like. Other IP-based telephony signaling protocols that may be employed are MGCP and SIP. Similarly, those skilled in the art will appreciate that, while the details of implementation must vary, the invention also can be implemented with other VoIP signaling protocols.

In the NCS protocol, both signaling and voice are transmitted within digital packets of data in well defined different streams. Voice is carried within Real Time Protocol (RTP) packets, and signaling is carried within Network Control Signaling (NCS) packets. The packets are constructed of a nested series of headers and the payload. The first header is the link layer, followed by an Internet Protocol (IP) header, a User Datagram Protocol (UDP) header, and then finally the NCS or RTP payload.

Among other things, the call agent 150 transmits to the MTAs 110 a text signal that conforms to the NCS protocol and which contains such information as the telephone number and/or the name of the incoming caller. This information is usually embodied in a text string incorporated into the text signal request. Examples of services using this text signaling feature include Calling Number Delivery (CND), Calling Identity Delivery on Call Waiting (CIDCW), and Calling Name Delivery (CNAM).

In a PacketCable VoIP signal, text information is derived in one of three ways: 1) when the originator of a call terminating to the PacketCable system is connected to the PSTN, the text information is transferred from the PSTN; 2) when the originator of the call terminating to the PacketCable system is connected to a call agent 150 other than the the call agent 150 served by the subscriber, the text information is transferred from the originating subscriber's call agent to the terminating subscriber's call agent 150; 3) when the originating subscriber and terminating subscriber are connected to the same call agent 150, the call agent determines the text information by interacting with provisioning and other back-office systems (not shown). For the purposes of illustration, the example presented herein assumes that the originating subscriber is connected to the PSTN. As those of ordinary skill in the art will recognize, the process is similar for all three cases.

When the call agent 150 receives the text signal from the PSTN 140, the relevant standards (e.g., GR-30 LSSGR Voiceband Data Transmission Interface, Generic Requirements, GR-31 LSSGR: CLASS Feature: Calling Number Delivery and GR-391 LSSGR: CLASS Feature: Calling Identity Delivery Blocking Features) specify a particular text string that is to be used if the calling party's number is unavailable or private. Specifically, the single character text string “O” is presented when the calling party's number is unavailable and the single character text string “P” when the number is private. The subscriber's text unit 125 often translates the single character text strings “O” and “P” (which are received by the text unit 125 in machine-readable form) to the human-readable text strings “Unavailable” and “Blocked,” respectively, which are then displayed for the subscriber. Text units generally do not support the translation of the single character text strings into multiple languages and thus they may not be able to display the text strings into a subscriber's native language.

To implement the translation of text strings in the text signal of an IP-based telephony signaling protocol, MTA 110₁ includes a memory 160. The memory 160 may be comprised of any type of computer-readable media, such as ROM, RAM, SRAM, FLASH, EEPROM, or the like. In particular, the memory 160 comprises non-volatile forms of memory such as ROM, Flash, or battery-backed SRAM such that programmed and user entered data is not required to be reloaded in the event of a power failure. Furthermore, the memory 160 may take the form of a chip, a hard disk, a magnetic disk, and/or an optical disk. Memory 160 may be logically (and possibly physically) divided into two or more program memory segments such as program memory segment 162, text translator segment 164 and phone directory memory segment 166. It will be appreciated that if the memory segments are physically divided, they need not all be of the same type. For instance, program memory segment 162 may be ROM while caller ID translator 164 may be Flash or other non-volatile read/write memory in order to allow the user to store new spoken entries for recognition. Additionally, each of these memory segments may themselves comprise a mixture of types, for instance either or both memories may include a small amount of RAM for use as transient, or temporary, storage during processing.

Text translator segment 164 stores the text strings employed by the NCS (or other telephony signaling protocol) text signal as well as the text strings to which NCS text strings are to be converted. For instance, if the end-user's native language is Spanish, the single character strings O” and “P” received from NCS text signal may be respectively associated with the corresponding Spanish words “UNAVAILABLE” and “BLOCKED.” The text string data may be entered into the text translator segment 164 by a technician prior to deployment of the MTA based on the anticipated country or region in which the MTA is be located or based on other factors such as user preference. In other cases the text translator segment 164 may be user-configurable so that the service provider or even the end-user himself or herself can customize the text strings so that the NCS text strings are converted into any desired text string for display on a text unit.

In some cases the text translator segment 164 may be able to store a multiplicity of strings representing the words “UNAVAILABLE” and “BLOCKED” in a multiplicity of languages. In this case the text translator segment 164 may also store a selection designating a preferred language that should be used for translation. The selection of a preferred language may be performed by the MSO. For instance, the text translator segment 164 may be supplied with this information along with all the other MTA configuration data. Optionally, the text translator segment 164 may be configured by the subscriber. Typically the subscriber will make the selection through a subscriber graphical user interface.

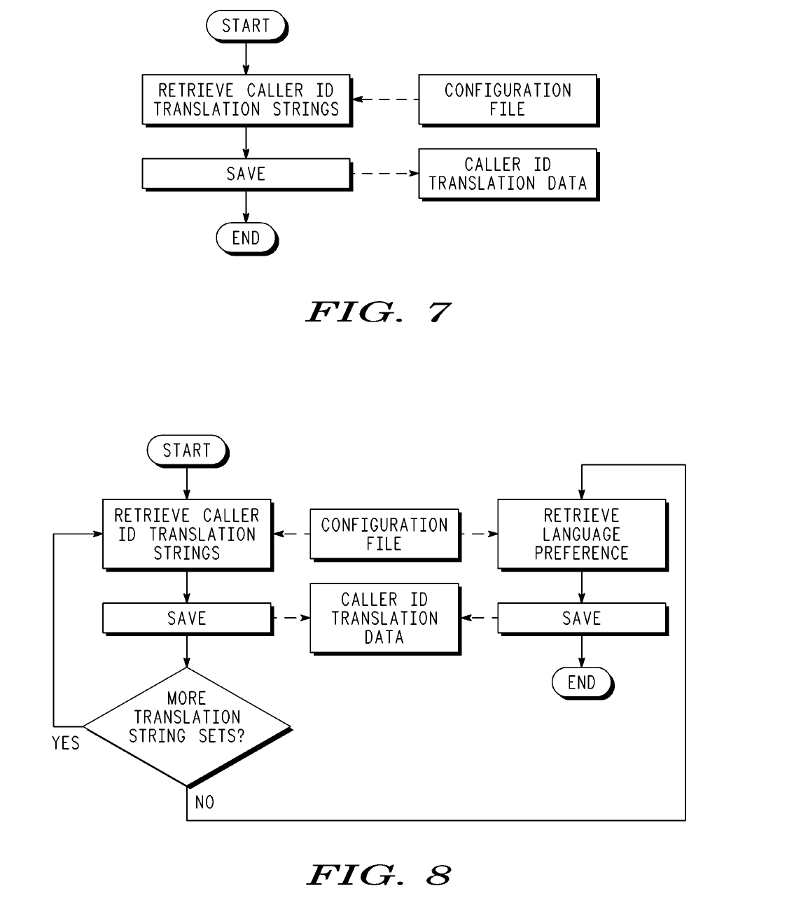

In the case where the text translator segment 164 stores just a single set of text strings for the subscriber's preferred language, the MSO can simply select the appropriate language and populate the MTA configuration file with the correct text strings, as depicted in FIG. 7.

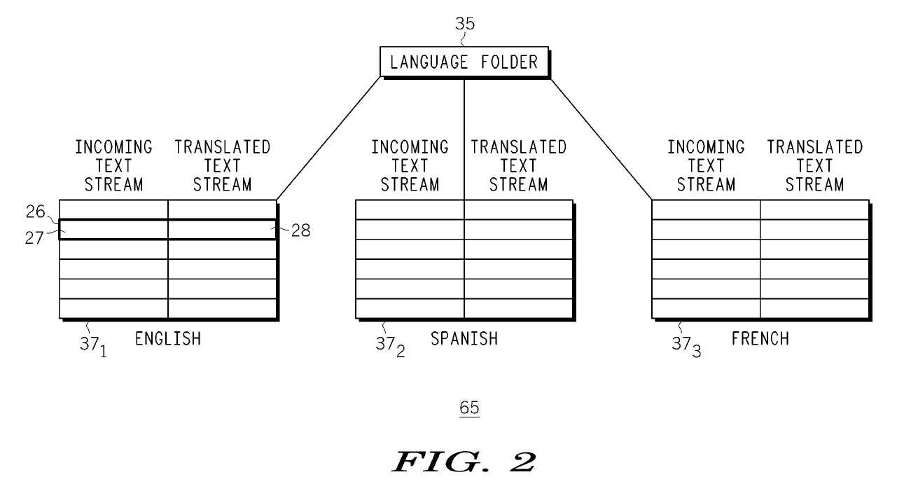

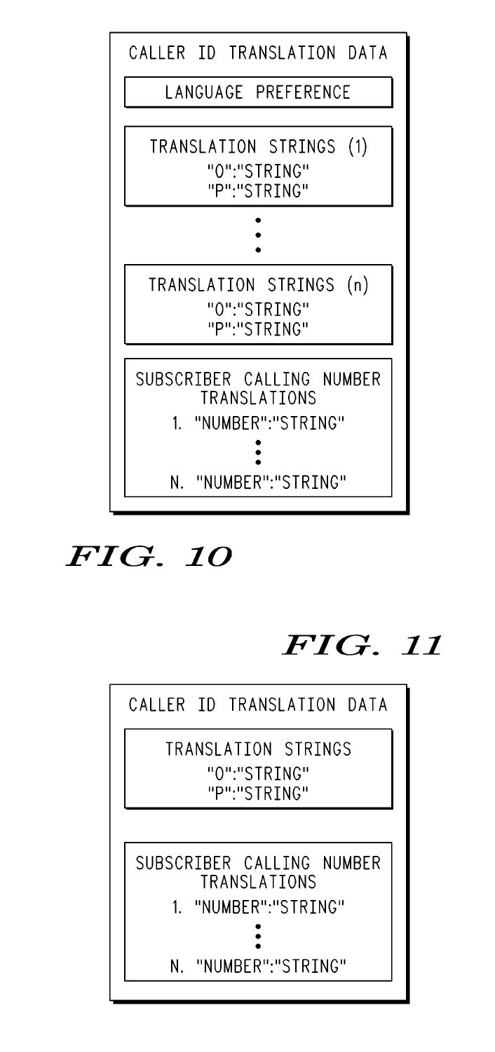

FIG. 2 shows an illustrative representation of the text translator database 65 stored in memory segment 164 indicating how the information may be structured and linked together. An alternative arrangement for structuring this information is discussed below in connection with FIGS. 10 and 11. While the database 65 in FIG. 2 is shown having a tree structure, any other appropriate arrangement may be employed to link together the data stored in database 65. The database includes a main folder 35 of translation tables 37, each of which represent a different language into which the call signaling text can be translated. For instance, in FIG. 2, translation tables 37₁-37₃ are shown for English, Spanish and French. There is one translation entry 26 for each text string that is to be translated. Each translation entry 26 consists of a incoming text string field 27 and the translated human-readable text string field 28. The number of entries will depend how many text strings are to be translated and is not limited to the two illustrative entries noted above which represent “Unavailable” and “Blocked.” Since not all geographic regions may employ the same number of text strings, the number of entries in the tables 37₁-37₃ may or may not be all the same. Of course, the text translator database 65 may be formatted in a wide variety of different configurations and is not limited to the particular configuration shown in FIG. 2.

As previously mentioned, if the MSO configures the MTA before it is deployed, the MSO may only populate the appropriate translation table or tables that will be needed in the particular geographic region in which the MTA is to be installed. In other cases such as when the subscriber selects the preferred language, all or some of the translation tables 37 may be populated and the subscriber makes the selection using the language folder 35, which in this case is a user-selectable field. This process is depicted in FIG. 8.

Returning to FIG. 1, the program memory segment 162 includes executable instructions that are intended to control the operation of the digital signal processor 124 to implement the translation process. The DSP 124 uses the executable instructions stored in program memory segment 162 to determine if the incoming text strings received from the NCS text signal match any entries in memory segment 162, and if so, retrieve the corresponding text string into which the matching entry is to be translated, after which it is forwarded to the text unit 125 for rendering.

To further facilitate the use of the call waiting feature, in some cases memory 160 may include a phone book memory segment request 166 that associates the name of a calling party with an incoming telephone number identified by the text. The name of the calling party may be provided by the customer through a keypad and/or a voice entry arrangement associated with the customer premises equipment or the MTA. The name field of memory segment 166 thus may store a text entry and/or a voice entry, depending on how the name is entered by the customer. Since the customer can customize the name field of the text service in this manner, the network service provider can be relieved of the need to provide this additional information.

Although MTA 110₁ has been illustrated as having various components for discussion purposes, those of skill in the art will appreciate that several components illustrated in MTA 110, such as host processor 126, DSP 124, CODEC 128 and cable modem 115 may implemented in a single programmable processor. Memory 160 may constitute one or more memory components, including removable memory components. Further, telephone 122 and/or text unit 125 may also be integrally formed with MTA 110.

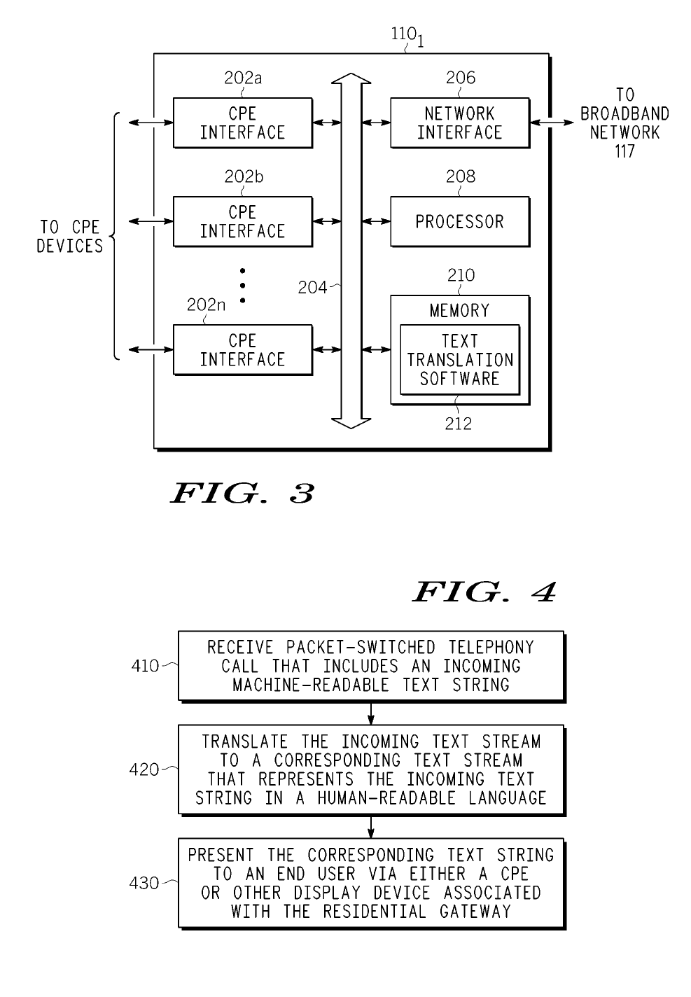

FIG. 3 is an alternative embodiment of the residential gateway or MTA 110₁ shown in FIG. 1, which is presented to shows the features of the residential gateway in a more generalized manner so that it is applicable to any type of broadband access network and which is configured to handle voice, multimedia and data. Residential gateway 110₁ includes a network interface 206, a plurality of CPE interfaces 202a-202n, at least one processor 208, and a memory 210, each of which are operatively and communicatively connected via a system bus 204.

Network interface 206 comprises the interface between residential gateway 110₁ and the broadband network 117 of FIG. 1. In part, network interface 206 implements the communication protocols necessary to receive data from broadband network 117 for further processing by residential gateway 110₁. For example, if the broadband network 117 is a cable modem network as shown in FIG. 1, network interface 206 may include a DOCSIS MAC and PHY for receiving and processing data in accordance with standard DOCSIS or other comparable protocols. Alternately, if the broadband network is an ADSL network, network interface 206 may include an ADSL analog front end (AFE) and transceiver for receiving and processing data in accordance with standard ADSL protocols. However, these examples are not limiting, and network interface 206 may include any interface for receiving data from broadband network, including, without limitation, a V.90 or other V.xx analog modem interface, an HDSL interface, an RADSL interface, an ISDN interface, a 10/100 Ethernet interface as well as various wireless interfaces such as VoWiFi.

Once data has been received from broadband network 117 via network interface 206, it is separated by data type into one or more channels, or data streams, of video, voice and/or computer data by network interface 206 and/or processor 208. Processor 208 then performs the necessary physical and link layer protocol conversions to transfer each data stream to one or more of CPE interfaces 202a-202n.

CPE interfaces 202a-202n each operate as an interface between residential gateway 110₁ and one or more CPE devices (e.g., telephone 122 in FIG. 1). In part, CPE interfaces 202a-202n implement the necessary communication protocols for transmitting data streams comprising video, voice or computer data from residential gateway 110₁ to one or more of the CPE devices. For example, CPE interfaces 202a-202n may include a Home Phone Network Alliance (HPNA) interface, an Ethernet interface, and/or a Universal Serial Bus (USB) interface for communication with or more CPE devices over an HPNA network, an Ethernet, and/or a USB, respectively. CPE interfaces 202a-202n may also include a POTS interface for connecting to one or more POTS phones, or a video interface for providing video signals to a television, VCR or the like. However, these examples are not limiting, and CPE interfaces 202a-202n may comprise any suitable interface.

The residential gateway 110₁ in FIG. 3 includes one or more processors 208 (which may in part correspond to host processor 126 in FIG. 1) that operates under the control of software stored in memory 210 (which may in part correspond to memory 160 in FIG. 1) Memory 210 stores text translation software 212 that is executed by processor 208 and that enables processor 208 to translate incoming machine-readable text strings (corresponding to human-readable text strings) associated with call signaling, which was initially described above in reference to FIG. 1.

FIG. 4 is a flowchart 10 illustrating a method by which MTA 110₁ presents information to a customer, which information is associated with a packet-switched telephony call received over a broadband communications network. The method begins in step 410 when the MTA 110₁ receives a packet-switched telephony call that includes an incoming machine-readable text string incorporated in a signal that conforms to a packet-switched telephony signaling protocol. Next, in step 420 the incoming machine-readable text string is translated (by e.g., text translator 164) to a predefined corresponding text string that represents the machine-readable text string in a human-readable language. Finally, in step 430 the corresponding text string is presented to an end user, either via the end user's customer premises equipment or via a display that is associated with or incorporated into the MTA 110₁ itself.

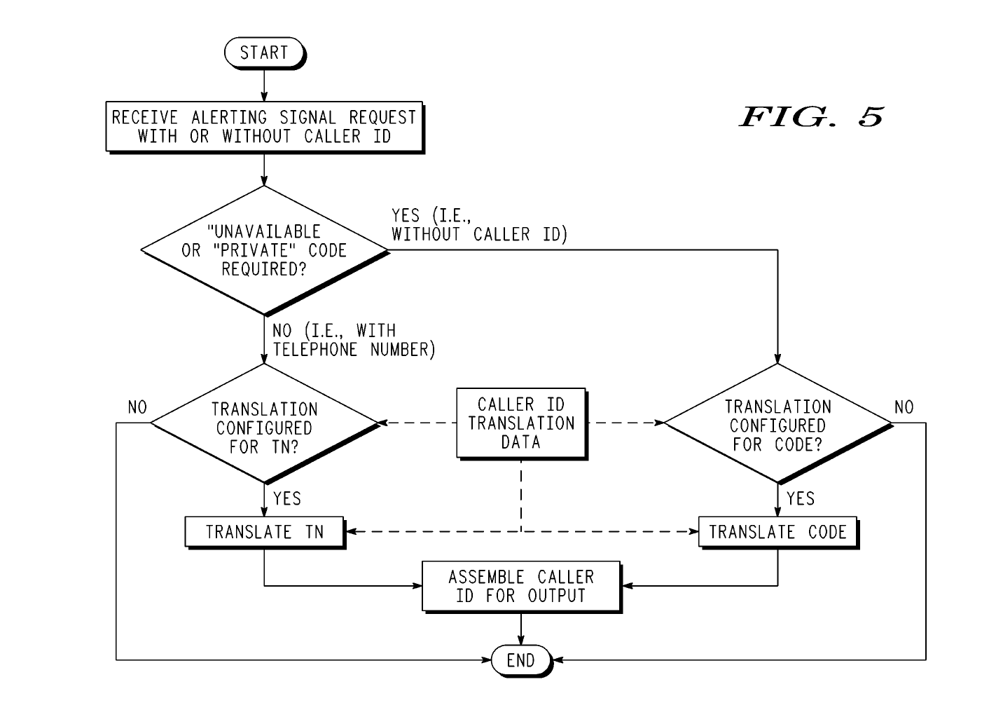

FIGS. 5-9 are flowcharts showing various examples of processes performed by the MTA depending on the information available to the MTA in its configuration file, and the manner in which the service is configured among the service provider, the MTA vendor and the customer. For instance, FIG. 5 shows a process in which the service provider has determined the subscriber's language preference, if any, at the time that is service is ordered or later at the subscriber's request. If a call is received with caller id codes representing unavailable or private calling numbers, the MTA determines if the received caller ID codes is located in its configuration file. If so, the code is translated and the output is presented to the user. If the call is received without such a code, that is, the caller id information received includes a calling number, and optionally a calling name, the MTA determines if its caller id translation data contains a subscriber-input translation for the calling number that is received. That is, the MTA determines if a translation is available from the subscriber's personal address book or the like. If so, the translation is presented to the user.

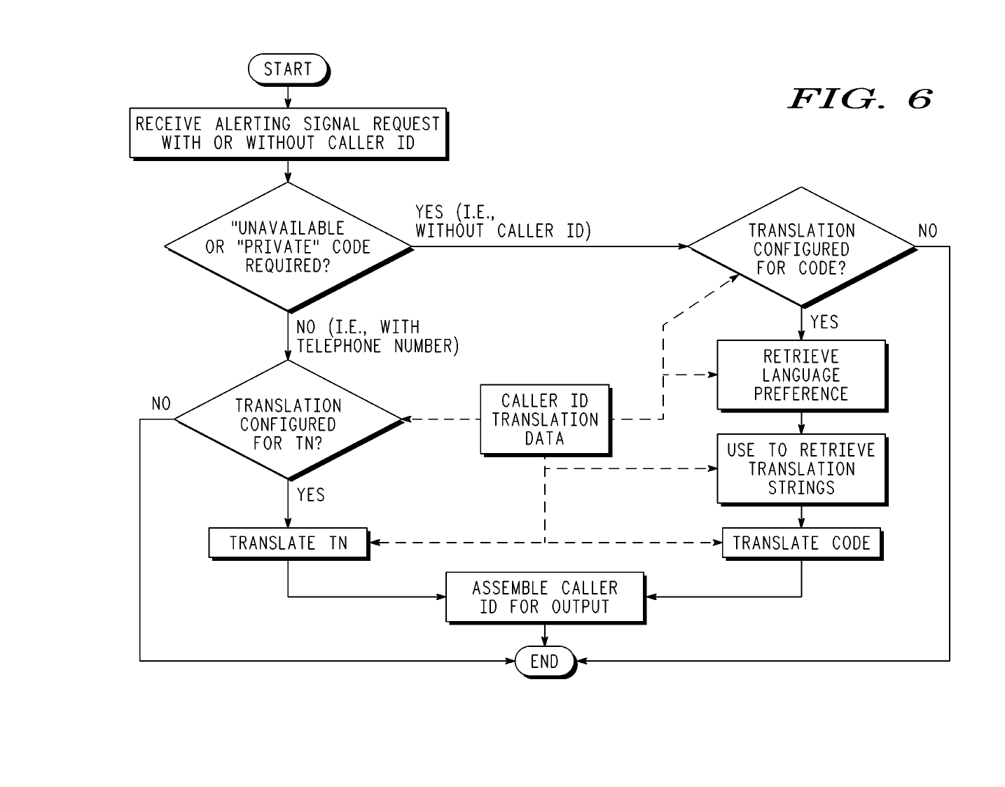

FIG. 6 is similar to FIG. 5 except that in FIG. 6 the MTA is configured to translate into multiple languages. In this case the MTA must retrieve the subscriber's language preference before translating the caller ID information.

FIG. 7 shows a simple process in which the MTA's configuration file contains a single translation string set for a language selected when the subscriber's account is created or at a subsequent time in response to a request from the subscriber. The process shown in FIG. 8 is similar to that depicted in FIG. 7 except that in FIG. 8 the MTA's configuration file contains multiple translation strings each of which correspond to a different subscriber language. The translation strings, along with a designated selection for the subscriber's language preference parameter, are stored in a caller ID translation data file or folder.

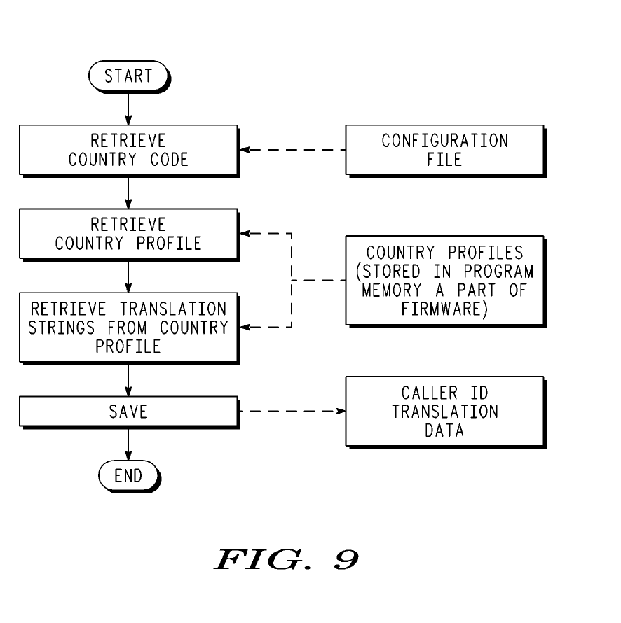

FIG. 9 shows a process in which the MTA's configuration file contains a country code. During initialization, the MTA retrieves the country code from the configuration file and uses it to populate the caller ID translation data file with the translated strings available from a country profile that corresponds to the retrieved country code. That is, the MTA uses the country code to select the correct profile and then copies the translation strings from that profile to the caller ID translation data file.

FIGS. 10 and 11 show examples of the information that may be available in the caller ID translation data file. FIG. 10 shows a caller ID translation data file in which multiple translation strings are stored for languages 1 through n. This information is available from the configuration file, or alternatively, from translations provided by the subscriber using the MTA user interface. FIG. 11 shows a more simplified example of the caller ID translation data file which contains only a single set of translation strings for a preselected language. Once again, this information is available from the configuration file, or alternatively, from translations provided by the subscriber using the MTA user interface.

The steps of the processes described above, which take place on MTAs 110, may be implemented in a general, multi-purpose or single purpose processor. Such processor will execute instructions, either at the assembly, compiled or machine-level, to perform that process. Those instructions can be written by one of ordinary skill in the art following the description provided herein and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), and/or packetized or non-packetized wireline or wireless transmission signals.

Accordingly, a method and apparatus have been described above which can advantageously present to individuals text-based information received with incoming call signaling in a language of their choice. Moreover, the method and apparatus described herein advantageously transfers control of the language dependency of calling signaling text from the network itself to the local residential gateway.

1. A residential gateway for providing packet-switched telephony service over a broadband communications network, comprising:
data terminal equipment having an interface for communicating with customer premises equipment; and
an electronic memory configured to store a directory that associates an incoming text string incorporated in a signal that conforms to a packet telephony signaling protocol with a corresponding text string, wherein the incoming text string is a machine-readable text string and the corresponding text string represents the machine-readable text string in a human-readable language; and
a processor configured to receive the incoming text string and retrieve from the memory the corresponding text string for presentation to customer premises equipment.

2. The residential gateway of claim 1 wherein the packet-switched telephony signaling protocol is an IP-based telephony signaling protocol.

3. The residential gateway of claim 2 wherein the IP-based telephony signaling protocol is NCS.

4. The residential gateway of claim 2 wherein the IP-based telephony signaling protocol is SIP.

5. The residential gateway of claim 2 wherein the residential gateway comprises an MTA.

6. The residential gateway of claim 1 wherein the incoming text string specifies that a phone number of an incoming caller is unavailable or blocked.

7. The residential gateway of claim 1 wherein the directory stored by the electronic memory associates the incoming text string with a plurality of different corresponding text strings.

8. The residential gateway of claim 7 wherein each of the corresponding text strings represents a human-readable text string in a different language.

9. The residential gateway of claim 1 further comprising a broadband modem for communicating data between the data terminal equipment and the broadband communications network.

10. The residential gateway of claim 1 further comprising a second electronic memory segment configured to store a directory that associates a telephone number incorporated in the signal with a name of a calling party associated with the telephone number.

11. The residential gateway of claim 1 wherein the customer premises equipment is a telephone.

12. The residential gateway of claim 1 wherein the packet-switched telephony connection conforms to a voice-over-IP protocol.

13. A computer readable medium containing instructions to cause a processor to perform a method of presenting information associated with a packet-switched telephony call received over a broadband communications network, the method comprising the steps of:
receiving a packet-switched telephony call that includes an incoming machine-readable text string incorporated in a signal that conforms to a packet-switched telephony signaling protocol;
translating the incoming machine-readable text string to a predefined corresponding text string that represents the machine-readable text string in a human-readable language; and
presenting the corresponding text string to an end user.

14. The computer readable medium of claim 13 wherein the packet-switched telephony signaling protocol is an IP-based telephony signaling protocol.

15. The computer readable medium of claim 14 wherein the IP-based telephony signaling protocol is NCS.

16. The computer readable medium of claim 14 wherein the IP-based telephony signaling protocol is SIP.

17. The computer readable medium of claim 14 wherein the packet-switched telephony call is received by an MTA.

18. The computer readable medium of claim 13 wherein the incoming text string specifies that a phone number of an incoming caller is unavailable or blocked.

19. The computer readable medium of claim 13 further comprising receiving a telephone number incorporated in the signal and retrieving from a database a name of a calling party associated with the telephone number and presenting the telephone number and the name of the calling party to the end user.

20. The computer readable medium of claim 13 wherein the packet-switched telephony call conforms to a voice-over-IP protocol.

21. The residential gateway of claim 13 wherein the directory stored by the electronic memory associates the incoming text string with a plurality of different corresponding text strings.

22. The residential gateway of claim 21 wherein each of the corresponding text strings represents the human-readable text string in a different language.

23. A method of presenting information associated with a packet-switched telephony call received over a broadband communications network, the method comprising:
receiving a packet-switched telephony call that includes an incoming machine-readable text string incorporated in a signal that conforms to a packet-switched telephony signaling protocol;
translating the incoming machine-readable text string to a predefined corresponding text string that represents the machine-readable text string in a human-readable language; and
presenting the corresponding text string to an end user.
